(19) United States
(12) Patent Application Publication
(10) Pub. No.: US 2024/0283119 A1
(43) Pub. Date: Aug. 22, 2024

(54) Hollow Conductor Having a Flexible Hollow Conductor Section and Mechanical Relief of a Joint

(71) Applicant: Tesat-Spacecom GmbH & Co. KG, Backnang (DE)

(72) Inventors: Andre Berger, Backnang (DE); Dennis Epple, Backnang (DE); Matthias Herte, Backnang (DE); Jean Parlebas, Backnang (DE); Andreas Scheffel, Backnang (DE); Gregor Wieczorek, Backnang (DE)

(73) Assignee: Tesat-Spacecom GmbH & Co. KG, Backnang (DE)

(21) Appl. No.: 18/581,857

(22) Filed: Feb. 20, 2024

(30) Foreign Application Priority Data
Feb. 21, 2023 (DE) 102023104255.6

(51) Int. Cl. H01P 1/04; H01P 3/14

(52) U.S. Cl. CPC H01P 1/042; H01P 3/14

(57) ABSTRACT

A hollow conductor has a first flange, a second flange, a flexible hollow conductor section, and a first fastening unit. The flexible hollow conductor section is electrically connected both to the first flange and to the second flange in such a way that a radio-frequency signal (RF signal) can be transmitted from the first flange to the second flange or vice versa via the flexible hollow conductor section. The flexible hollow conductor section has a surface, and a first depression is arranged in the surface. The first fastening unit is connected to the first flange. The first fastening unit rests against the surface of the flexible hollow conductor section in a first overlap region in a longitudinal direction of the flexible hollow conductor section and engages in the first depression of the flexible hollow conductor section and thereby fixes the flexible hollow conductor section with respect to the first flange.

### FIELD OF THE INVENTION

In general terms, the present description relates to the technical field of signal transmission technology and, in particular, to a hollow conductor for transmitting RF signals having a flexible hollow conductor section.

### BACKGROUND OF THE INVENTION

Hollow conductors are used in signal transmission technology to transmit signals, especially radio-frequency signals, e.g. with frequency components of 1 GHz and higher. Hollow conductors are used in satellite communications, for example.

In addition to requirements on the signal transmission properties, a hollow conductor must also, depending on the application, satisfy mechanical requirements. Thus, it may be necessary to make a hollow conductor structurally or mechanically flexible in order to allow tolerance compensation and to absorb thermomechanical stresses or vibration.

A hollow conductor generally consists of two flanges and a hollow conductor section situated between them. The flanges serve to connect the hollow conductor to the components to be connected. The hollow conductor section, in turn, is electrically and mechanically connected to the two flanges. It is precisely in the case of hollow conductors that have flexible hollow conductor sections that the electric/mechanical connection between the hollow conductor section and the flanges can be exposed to high loads, and there is also the risk of damage to this electric/mechanical connection owing to repeated relative movements between the flanges and the hollow conductor section. Even if said electric/mechanical connection between the hollow conductor section and a flange still has sufficient mechanical strength, it may nevertheless be the case that the signal transmission properties are impaired in an undesirable manner by structural damage. However, it is also conceivable that, to achieve a desired signal transmission quality, the electric/mechanical connection must be configured in such a way that it is not even possible to achieve high mechanical strength over a prolonged period.

In other words, there is the risk, in the case of hollow conductors with flexible hollow conductor sections, of damage at a joint between the flexible hollow conductor section and some other component of the hollow conductor, e.g. at the joint between the flexible hollow conductor section and a flange.

### BRIEF SUMMARY OF THE INVENTION

Proceeding from the above-described disadvantage of the prior art, an aspect relates to improving a hollow conductor having a flexible hollow conductor section in such a way that the risk of mechanical damage and/or unwanted impairment of the signal transmission properties in continuous operation and under mechanical loads is reduced.

According to one aspect, a hollow conductor is specified. A hollow conductor can also be referred to as a waveguide and is used, for example, to transmit radio-frequency signals (RF signals). The hollow conductor has a first flange, a second flange, a flexible hollow conductor section, and a first fastening unit. The flexible hollow conductor section is electrically connected both to the first flange and to the second flange in such a way that a radio-frequency signal (RF signal) can be transmitted from the first flange to the second flange or vice versa via the flexible hollow conductor section. The flexible hollow conductor section has a surface, and a first depression is arranged in the surface. The first fastening unit is connected to the first flange. The first fastening unit rests against the surface of the flexible hollow conductor section in a first overlap region in a longitudinal direction of the flexible hollow conductor section and engages in the first depression of the flexible hollow conductor section and thereby fixes the flexible hollow conductor section with respect to the first flange.

The first flange and the second flange serve to connect the hollow conductor to the signal-processing components to be connected to one another. For this purpose, the flanges can be of appropriate configuration. For example, the first flange is connected to a first component to enable an RF signal to be fed into the hollow conductor from the first component via the first flange. This RF signal is then transmitted to the second flange via the flexible hollow conductor section. The second flange is connected to a second component and makes it possible for the second component to pick off the RF signal at the second flange. In order to connect the first flange and the second flange to the respective signal-processing components to be connected to one another, all known techniques can be used.

In a hollow conductor, electromagnetic signals are transmitted by means of a hollow body. In the present description, the hollow body is the flexible hollow conductor section. The flexible hollow conductor section can have various cross-sectional shapes, e.g. rectangular (with corners that are rounded or not rounded), circular or elliptical, to name just a few possible cross-sectional shapes, purely by way of example and without limitation. The hollow body is defined by a lateral surface and is delimited in the lateral direction. Depending on the cross-sectional shape, the lateral surface can consist of a curved surface (in the case of a circular or elliptical cross section) or of a plurality of surfaces that can be distinguished as separate side faces (in the case of a rectangular cross section).

In the present case, the hollow conductor section is a flexible hollow conductor section. The flexible hollow conductor section allows a certain degree of freedom of movement because the flexible hollow conductor section is deformable, allowing bending transversely to its longitudinal direction but also permitting compression or elongation along its longitudinal direction, for example. The flexibility results, in particular, from the geometrical configuration of the material of the flexible hollow conductor section.

For example, the flexible hollow conductor section comprises an electrically conductive material which is shaped in a kind of lamellar structure or corrugated structure. This structure makes it possible for the flexible hollow conductor section to be less rigid than a hollow conductor section whose side faces are made from a planar material. At least in some section or sections, the configuration of the surface of the flexible hollow conductor section resembles that of a bellows. The side faces of the hollow conductor section thus have corrugations or lamellae in order, by means of this shape, to allow a greater deformability of the hollow conductor section in comparison with a hollow conductor section that has flat/planar side faces without the corresponding deformations.

In principle, it is sufficient if one depression in which the first fastening unit can engage is arranged in the surface of the flexible hollow conductor section. The above-described lamellar structure has a plurality of such depressions, which recur at regular or irregular intervals in the longitudinal direction of the flexible hollow conductor section. In particular, the first depression in the surface of the flexible hollow conductor section is arranged close to a first end of the hollow conductor section.

Here, a depression is understood to mean a relative depression, wherein the relative depression is stepped in the direction of the interior of the hollow conductor section, starting from a surface of the flexible hollow conductor section which surrounds the depression.

Thus, the first fastening unit engages in a depression of the flexible hollow conductor section and thereby represents a positive connection. The first fastening unit thereby fixes the flexible hollow conductor section with respect to the first flange. A mechanical load acting on the flexible hollow conductor section is thus absorbed by the first fastening unit, and this mechanical load is largely or completely kept away from the electric connection between the flexible hollow conductor section and the first flange.

The depression or depressions in the surface of the flexible hollow conductor section result, for example, from the fact that the side faces of the hollow conductor section are correspondingly shaped and, for example, have the shape of a corrugated sheet (lamellar structure, corrugated structure, in the manner of a bellows). This is appropriate, for example, in the case of hollow conductor sections consisting of a relatively thin material with a wall thickness of from a few tenths of a millimeter to a few millimeters. In the case of a hollow conductor section consisting of a material with a greater wall thickness, it is also conceivable for a depression or a plurality of depressions to be machined into the material of the hollow conductor section by removing material using a method that involves consuming material or machining it away. In the case of flexible hollow conductor sections, however, it is appropriate to engage in the depressions provided by the lamellar structure and to use these to fix the flexible hollow conductor section.

The first fastening unit serves to mechanically fix the flexible hollow conductor section with respect to the first flange and to prevent a relative movement between the first end of the flexible hollow conductor section and the first flange when external forces act on the hollow conductor and, for example, the second flange is moved with respect to the first flange or the flexible hollow conductor section is deformed on account of forces which act directly on the flexible hollow conductor section. Since a relative movement between the first end of the flexible hollow conductor section and the first flange is prevented, the electric connection between the first end of the flexible hollow conductor section and the first flange is relieved of mechanical loads.

The flexible hollow conductor section is typically connected to the first flange by a soldered connection or an electrically conductive adhesive connection. If, however, the flexible hollow conductor section is moved with respect to the first flange, this weakens the soldered connection or the electrically conductive adhesive connection with time, and the soldered connection or electrically conductive adhesive connection may break. Particularly in the case of a hollow conductor which is used for transmitting radio frequency signals, such a break in the electric connection between the hollow conductor section and the flange represents a very major impairment of the transmission quality of the hollow conductor, or even outage.

The construction described here using a fastening unit relieves the mechanical load on the soldered connection, thereby significantly reducing the risk of impairments to the signal transmission quality due to mechanical damage at the connection between the hollow conductor section and the flange.

According to one embodiment, the flexible hollow conductor section has a first end, and the first end is electrically connected to the first flange, and the flexible hollow conductor section has a second end, and the second end is electrically connected to the second flange.

For example, each end of the flexible hollow conductor section is soldered, adhesively bonded in an electrically conductive manner, or welded to the respective flange, depending on the requirements on the quality of the signal transmission via the hollow conductor.

The hollow conductor described here has, at at least one flange, a double connection between the flexible hollow conductor section and this flange, wherein a first connection of the double connection essentially has the function of electrically connecting the flexible hollow conductor section to the corresponding flange, and wherein a second connection of the double connection essentially has the function of mechanically connecting the flexible hollow conductor section to the corresponding flange and preventing a relative movement between the end of the hollow conductor section and the corresponding flange to ensure that the first connection (the electric connection) is subject to the least possible or even no mechanical stress.

According to another embodiment, the first fastening unit at least partially surrounds the flexible hollow conductor section in a circumferential direction of the flexible hollow conductor section.

When viewed in the circumferential direction of the flexible hollow conductor section, the fastening unit is, for example, of C-shaped or annular configuration (in the latter case, the first fastening unit completely surrounds the flexible hollow conductor section in the circumferential direction), and extends at least partially around the flexible hollow conductor section in the circumferential direction and, at the same time, rests against the surface of the flexible hollow conductor section.

For example, the fastening unit engages around the flexible hollow conductor section in the circumferential direction to the extent that it engages around more than half of the circumference of the flexible hollow conductor section. In this way, the fastening unit fixes the flexible hollow conductor section in such a way on the corresponding flange that a movement of the flexible hollow conductor section transversely to a longitudinal direction of the flexible hollow conductor section is prevented. A movement of the flexible hollow conductor section in the longitudinal direction away from the corresponding flange is prevented by the fact that the fastening unit engages in the first depression in the surface of the flexible hollow conductor section. Thus, the fastening unit absorbs all the lateral movements of the flexible hollow conductor section with respect to the flange.

Rotational movements of the flexible hollow conductor section can be prevented by the fact that the flexible hollow conductor section has a cross-sectional shape which deviates from a circle, as a result of which a rotational movement of the flexible hollow conductor section in the first fastening unit is prevented since the first fastening unit is matched to the external shape of the periphery of the flexible hollow conductor section.

According to another embodiment, the first depression in the surface of the flexible hollow conductor section is a groove or slot which extends in the circumferential direction.

The first fastening unit engages in this first depression and, owing to the extent of the depression in the circumferential direction, a force acting in the longitudinal direction of the flexible hollow conductor is absorbed by the first fastening unit, and this force is thus kept away from the electric connection between the flexible hollow conductor section and the flange.

It is conceivable that additional depressions are also provided in the longitudinal direction in the surface of the hollow conductor section, wherein the fastening unit also engages in these depressions by means of a corresponding mating part (that is to say a raised portion on the fastening unit). Depressions extending in the longitudinal direction of the hollow conductor section can serve to absorb a force in the circumferential direction and to prevent a rotational movement of the hollow conductor section with respect to the flange.

According to another embodiment, the flexible hollow conductor section has a plurality of first depressions and first raised portions in its surface, wherein a first raised portion is arranged between each two successive first depressions in the longitudinal direction of the flexible hollow conductor section, and the plurality of first depressions and first raised portions extends in the circumferential direction of the flexible hollow conductor section.

In this description, the first depression and the first raised portion or the first depressions and the first raised portions relate to the structure of the surface of the flexible hollow conductor section at the first end, which is connected to the first flange by means of the first fastening unit. In the further course of the description, reference is also made to a second depression and a second raised portion, but these relate to the structure of the surface of the flexible hollow conductor section at the second end, which is connected to the second flange by means of the second fastening unit.

For example, the flexible hollow conductor section is formed from a corrugated or lamellar material, resulting in the flexibility of the hollow conductor section. This form of the flexible hollow conductor section, in turn, is used to ensure that the first fastening unit engages in the corresponding depressions and mechanically fixes the flexible hollow conductor section with respect to the respective flange.

The flexible hollow conductor section has the raised portions and depressions over its entire length, for example. However, it is also conceivable for the flexible hollow conductor section to be provided with said raised portions and depressions only in some section or sections (in the longitudinal direction). The raised portions and depressions are provided at least in the region of the first and/or second end of the flexible hollow conductor section, depending on whether one end of the flexible hollow conductor section is connected to the associated flange via the fastening unit or whether a fastening unit is arranged at both ends of the flexible hollow conductor section.

According to another embodiment, the first fastening unit has at least one first raised portion, which is arranged so as to engage in the first depression in the surface of the flexible hollow conductor section.

In the context of the first fastening unit and the second fastening unit too, the terms “first raised portion” and “first depression” as well as “second raised portion” and “second depression” are used, wherein the first raised portion and the first depression relate to features of the first fastening unit, and the second raised portion and the second depression relate to features of the second fastening unit. The first fastening unit engages in the surface features of the flexible hollow conductor section at the first end, and the second fastening unit engages in the surface features of the flexible hollow conductor section at the second end.

The first fastening unit on the surface which rests against the surface of the flexible hollow conductor section in the overlap region between the first fastening unit and the flexible hollow conductor section is preferably configured in the manner of a negative of the surface of the flexible hollow conductor section. In other words, therefore, the surfaces of the first fastening unit and of the flexible hollow conductor section which rest against one another engage in one another in the overlap region. By virtue of the shape and/or the direction of extent of the depression or depressions and, where applicable, of the raised portions, the fastening unit holds the flexible hollow conductor section on the corresponding flange and prevents the flexible hollow conductor section from moving relative to the flange in the longitudinal direction.

According to another embodiment, the first fastening unit is connected to the first flange by means of a screwed connection, a riveted connection, a clamp connection, a strap, or an adhesive connection.

In principle, the first fastening unit can be mechanically connected to the first flange in any desired manner as long as this connection has sufficient strength to absorb the expected forces acting on the flexible hollow conductor section and to keep them away from the electric connection between the flexible hollow conductor section and the flange. A plurality of individual connecting elements, such as screws, rivets, straps, clamps or spots of adhesive can be used to produce the mechanical connection between the first fastening unit and the first flange.

According to another embodiment, the first fastening unit has a first segment and a second segment, wherein the first segment and the second segment rest against the surface of the flexible hollow conductor section at different points in the circumferential direction.

The first fastening unit can be formed by two half shells, for example, wherein each half shell forms a segment. Both half shells form the fastening unit and rest against the surface of the flexible hollow conductor section. In the assembled state of the two half shells, the flexible hollow conductor is at least partially or even completely surrounded by the two half shells in the circumferential direction.

By virtue of this construction, it is possible first of all to establish the electric connection (e.g. soldered connection) between the flexible hollow conductor section and a flange and only then to move the two segments of the fastening unit into position on the surface of the flexible hollow conductor section and to mechanically connect said unit to the flange.

It is conceivable that the first fastening unit consists of more than two segments, wherein each of the segments is connected in the assembled state to the flange and/or to one of the other segments.

According to another embodiment, the first segment is mechanically connected to the first flange and/or to the second segment, wherein the second segment is mechanically connected to the first flange and/or to the first segment.

The individual segments can be mechanically connected both to one another and to the respective flange. For example, adjacent segments can be connected to one another by means of a clamp or plug connection when the first fastening unit is mounted, and then the individual segments can also be mechanically connected to the respective flange.

According to another embodiment, the hollow conductor furthermore has a second fastening unit, wherein the second fastening unit is connected to the second flange, wherein the second fastening unit rests against the surface of the flexible hollow conductor section in a second overlap region in a longitudinal direction of the flexible hollow conductor section and engages in a first depression of the flexible hollow conductor section and thereby fixes the flexible hollow conductor section with respect to the second flange.

In this embodiment, the hollow conductor is configured in such a way that both ends of the flexible hollow conductor section are mechanically connected to the respective flange by means of a respective fastening unit. The statements made with reference to the first flange, the first fastening unit and the first overlap region apply mutatis mutandis to the connection between the second fastening unit and the second flange and the connection between the second fastening unit and the flexible hollow conductor section in the second overlap region.

It may be sufficient to mechanically fix just one end of the flexible hollow conductor section with respect to a flange by means of a fastening unit because, for example, higher forces occur at the corresponding end of the flexible hollow conductor section than at the other end. Preferably, however, both ends of the flexible hollow conductor section are mechanically connected to the corresponding flange by means of a respective fastening unit.

### BRIEF DESCRIPTION OF THE DRAWINGS

A number of details are described in greater detail below with reference to the attached drawings. The illustrations are schematic and not to scale. Identical reference signs refer to identical or similar elements. More specifically:

FIG. 1 shows a schematic illustration of a hollow conductor with a flexible hollow conductor section;

FIG. 2 shows a schematic illustration of a hollow conductor with a flexible hollow conductor section and two fastening units, which fix the flexible hollow conductor section with respect to the flanges;

FIG. 3 shows a schematic illustration of a sectional view of the connection between a flexible hollow conductor section and a flange by means of a fastening unit;

FIG. 4 shows a schematic illustration of a fastening unit with two segments, which are connected to a flange.

### DETAILED DESCRIPTION

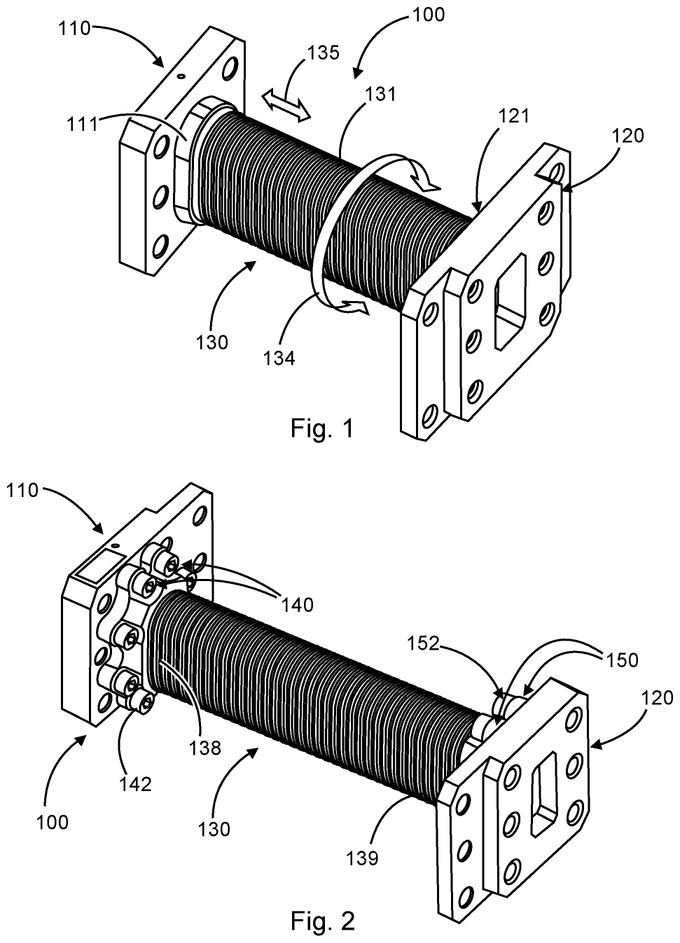

FIG. 1 shows a hollow conductor 100 having a first flange 110, a second flange 120 and a flexible hollow conductor section 130 arranged between them. The flexible hollow conductor section 130 extends in the longitudinal direction 135 between the first flange 110 and the second flange 120 and is connected to the first flange 110 in a first connecting region 111 and to the second flange 120 in a second connecting region 121. The flexible hollow conductor section 130 has a surface 131. A plurality of depressions and raised portions is formed in the surface 131. The depressions are, for example, slots or grooves which extend in the circumferential direction 134 of the flexible hollow conductor section 130.

Hollow conductors with a flexible hollow conductor section or, more generally, flexible hollow conductors are used where a geometry or shape of the hollow conductor which is variable or cannot be predetermined precisely in advance is required. Reasons for the flexibility required of the hollow conductor can be tolerance compensation, thermomechanical stress during operation, changes in position due to external temperature, vibration or even due to pivoting mechanisms, for example. Fundamentally, these flexible hollow conductors consist of two flanges 110, 120 with a flexible hollow conductor section 130 between them. This flexible hollow conductor section 130 is firmly connected to the flanges 110, 120, e.g. by means of respective soldered connections or electrically conductive adhesive connections in the connecting regions 111, 121. On the one hand, this soldered/adhesive connection ensures that the two flanges 110, 120 are mechanically connected to one another by the flexible hollow conductor section 130 and are thus mechanically stable to a certain extent and, on the other hand, that the complete hollow conductor track is electrically connected and thus satisfies requirements on the electromagnetic compatibility.

In general, the flanges 110, 120 consist of aluminum, but can also be produced from other suitable materials. Owing to the required good electric conductivity, these flanges 110, 120 can be coated with noble metals. The flexible hollow conductor section 130 consists, for example, of copper beryllium (CuBe) but other springy materials are also possible. The flexible hollow conductor section can also be coated with highly conductive metals. The imparting of flexibility to the hollow conductor section is achieved by geometrical shaping into a corrugated structure, but it can also be achieved by means of a spiral coil structure, for example.

FIG. 2 shows a hollow conductor 100 with the fundamental construction described with reference to FIG. 1. The components already described will therefore not be explained further. In addition to the components shown in FIG. 1, the hollow conductor 100 has a first fastening unit 140 and a second fastening unit 150. The first fastening unit 140 connects a first end 138 of the flexible hollow conductor section 130 to the first flange 110. The first fastening unit 140 is connected to the first flange 110 by a plurality of fastening means 142. In this example, the fastening means 142 are screws, but may also be rivets, bolts, clamps or other mechanical connecting elements. The first flange 110 has a plurality of openings, into which the fastening means 142 are inserted in order to connect the first fastening unit 140 to the first flange 110. In addition, the first flange 110 has further openings to enable the first flange 110 to be connected to an external component, which, as a signal-processing component, outputs a signal on the first flange 110 or picks off a signal at the first flange 110.

In a similar way to that described with reference to the first end 138, the second end 139 of the flexible hollow conductor section 130 is connected to the second flange 120 by means of the second fastening unit 150 and corresponding fastening means 152.

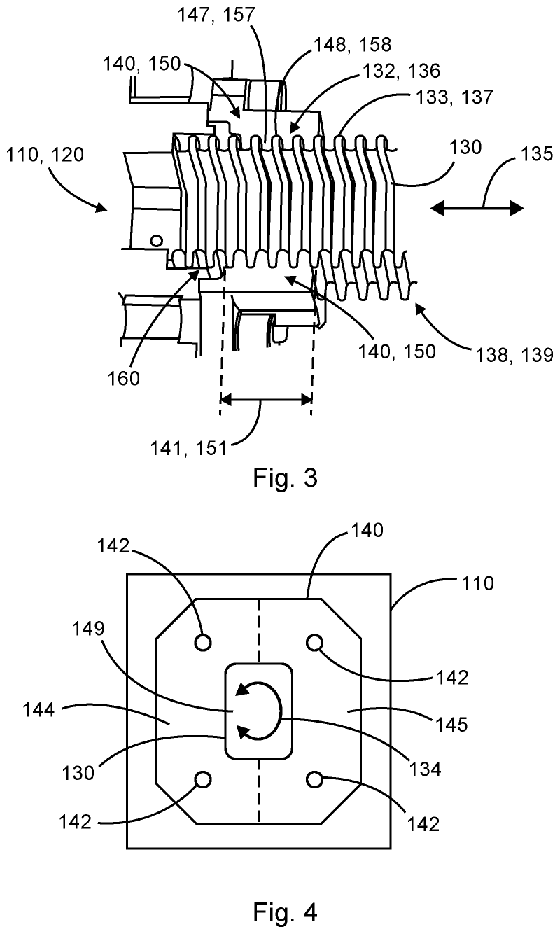

FIG. 3 shows a sectional illustration of one end 138, 139 of the flexible hollow conductor section 130 and the manner in which this end 138, 139 is connected to a flange 110, 120.

The illustration in FIG. 3 applies mutatis mutandis both to the connection between the first end 138 and the first flange 110 and to the connection between the second end 139 and the second flange 120. For this reason, the reference signs for the first flange 110, the first end 138, and the first fastening unit 140 as well as for the second flange 120, the second end 139, and the second fastening unit 150 are used in the illustration in FIG. 3.

The end 138, 139 of the flexible hollow conductor section 130 is first of all inserted into an opening in the flange 110, 120 and is connected to the flange 110, 120 by an electric connection 160. The electric connection 160 is, for example, a soldered connection or an electrically conductive adhesive connection and serves to enable an RF signal to be fed into the hollow conductor via the flange or enables an RF signal transmitted via the hollow conductor to be picked off at the flange. The connection 160 contributes to achieving a high signal transmission quality via the hollow conductor. Mechanical damage to this connection 160 can impair the signal transmission quality in an undesirable manner.

The fastening unit 140, 150 absorbs mechanical loads and forces which result from a movement or bending of the flexible hollow conductor section 130 and transmits these into the flange 110, 120 without these mechanical loads and forces acting on the connection 160.

The flexible hollow conductor section 130 extends in the longitudinal direction 135, and the lateral surface of the flexible hollow conductor section 130 is formed by a lamellar structure or corrugated structure, as can be seen from the alternating depressions 132, 136 and raised portions 133, 137 in the surface of the flexible hollow conductor section 130.

The fastening unit 140, 150 is fastened on the flange 110, 120 and rests against the surface of the flexible hollow conductor section 130. For its part, the fastening unit 140, 150 has raised portions 147, 157 and depressions 148, 158, which engage in the raised portions and depressions in the surface of the flexible hollow conductor section 130. In other words, the fastening unit 140, 150 forms a negative of the form or shape of the surface of the flexible hollow conductor section 130 in the overlap region 141, 151, with the result that the fastening unit 140, 150 engages by means of its raised portions and depressions in the raised portions and depressions of the surface of the flexible hollow conductor section 130.

A positive connection is established between the fastening unit 140, 150 and the end 138, 139 of the flexible hollow conductor section 130 in order to prevent a relative movement between the flexible hollow conductor section 130 and the flange 110, 120. This construction keeps forces and mechanical loads away from the connection 160 to a very large extent.

FIG. 4 shows a schematic plan view of the first flange 110 and the first fastening unit 140 connected thereto from the perspective of the flexible hollow conductor section 130. The first fastening unit 140 consists of a first segment 144 and a second segment 145. The first segment 144 and the second segment 145 are positioned on the first flange 110 and connected to the first flange 110 in such a way that an opening 149 is formed, in which the flexible hollow conductor section 130 (not shown) is arranged. The first segment 144 and the second segment 145 are each connected to the first flange 110 by means of fastening means 142 after the flexible hollow conductor section 130 has already been connected to the first flange 110. When the first segment 144 and the second segment 145 are in the assembled position, the raised portions of the fastening unit are in engagement with the depressions on the surface of the flexible hollow conductor section 130, as shown in FIG. 3.

The shape of the opening 149 also corresponds to the cross-sectional shape of the flexible hollow conductor section. In the present case, the opening 149 has a substantially rectangular shape with rounded corners. When the first segment 144 and the second segment 145 of the fastening unit 140 are arranged around the flexible hollow conductor section 130, this shape of the opening 149 and the cross-sectional shape of the flexible hollow conductor section 130 make it impossible for the hollow conductor section 130 to perform a rotational movement in the circumferential direction 134.

Thus, the fastening unit 140 is configured to withstand both a rotational movement and a translational movement of the flexible hollow conductor section 130 with respect to the flange 110.

The statements made in relation to the illustration in FIG. 4 also apply mutatis mutandis to the second flange 120 and the second fastening unit 150.

In summary, the hollow conductor illustrated here can be described as follows:

In the event of a relatively large mechanical load, e.g. owing to the necessity of being able to move the hollow conductor 100 during use, fastening units 140, 150 are attached in order to relieve the soldered connection 160 of mechanical loads. The fastening units 140, 150 consist, for example, of the same material as the flanges 110, 120 and comprise a structure corresponding to the flexible hollow conductor section at a contact surface with the surface of the flexible hollow conductor section. In particular, the surface structure of the fastening unit can reflect a negative structure of the surface of the flexible hollow conductor section at the contact surface, but any mechanical structure that intermeshes with the flexible hollow conductor section is suitable for fixing the flexible hollow conductor section with respect to the flange and ensuring corresponding force transmission. By means of this intermeshing lamellar structure and the fastening of the fastening units 140, 150 to the flange 110, 120, the flexible hollow conductor section 130 is held fast in the direction of the flange 110, 120. Thus, no mechanical load caused, for example, by bending or by tensile/compressive stressing of the flexible hollow conductor section 130 can affect the soldered connection 160. In one example, the fastening unit 140, 150 consists of two segments 144, 145 but, in principle, greater segmentation with a higher number of segments is also possible. The connection of the fastening units 140, 150 relative to the flange 110, 120 is not limited to screws; here too, other connecting techniques, such as adhesive bonding or even preloading using a clamp mechanism are possible.

In addition, it should be noted that “comprising” or “having” does not exclude other elements or steps and “a” or “an” does not exclude a multiplicity. Furthermore, it should be noted that features or steps which have been described with reference to one of the above exemplary embodiments can also be used in combination with other features or steps of other exemplary embodiments described above. Reference signs in the claims are not to be regarded as a restriction.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 hollow conductor
110 first flange
111 connecting region
120 second flange
121 connecting region
130 flexible hollow conductor section
131 surface
132 first depression in the surface
133 first raised portion
134 circumferential direction
135 longitudinal direction, direction of propagation of the corrugations
136 second depression
137 second raised portion
138 first end
139 second end
140 first fastening unit
141 overlap region
142 fastening means
144 first segment
145 second segment
147 first raised portion
148 first depression
149 opening
150 second fastening unit
151 overlap region
152 fastening means
154 first segment
155 second segment
157 second raised portion
158 second depression
159 opening
160 electric connection

1. A hollow conductor comprising:
a first flange;
a second flange;
a flexible hollow conductor section; and
a first fastening unit;
wherein the flexible hollow conductor section is electrically connected both to the first flange and to the second flange in such a way that a radio-frequency signal (“RF signal”) can be transmitted from the first flange to the second flange or vice versa via the flexible hollow conductor section;
wherein the flexible hollow conductor section has a surface, and a first depression is arranged in the surface;
wherein the first fastening unit is connected to the first flange; and
wherein the first fastening unit rests against the surface of the flexible hollow conductor section in a first overlap region in a longitudinal direction of the flexible hollow conductor section and engages in the first depression of the flexible hollow conductor section and thereby fixes the flexible hollow conductor section with respect to the first flange.

2. The hollow conductor as claimed in claim 1,
wherein the flexible hollow conductor section has a first end, and the first end is electrically connected to the first flange; and
wherein the flexible hollow conductor section has a second end, and the second end is electrically connected to the second flange.

3. The hollow conductor as claimed in claim 1,
wherein the first fastening unit at least partially surrounds the flexible hollow conductor section in a circumferential direction of the flexible hollow conductor section.

4. The hollow conductor as claimed in claim 3,
wherein the first depression in the surface of the flexible hollow conductor section is a groove or slot which extends in the circumferential direction.

5. The hollow conductor as claimed in claim 3,
wherein the flexible hollow conductor section has a plurality of first depressions including the first depression and first raised portions in its surface, wherein a first raised portion is arranged between each two successive first depressions in the longitudinal direction of the flexible hollow conductor section, and the plurality of first depressions and first raised portions extend in the circumferential direction of the flexible hollow conductor section.

6. The hollow conductor as claimed in claim 1,
wherein the first fastening unit has at least one first raised portion, which is arranged so as to engage in the first depression in the surface of the flexible hollow conductor section.

7. The hollow conductor as claimed in claim 1,
wherein the first fastening unit is connected to the first flange by a screwed connection, a riveted connection, a clamp connection, a strap, or an adhesive connection.

8. The hollow conductor as claimed claim 1,
wherein the first fastening unit has a first segment and a second segment; and
wherein the first segment and the second segment rest against the surface of the flexible hollow conductor section at different points in the circumferential direction.

9. The hollow conductor as claimed in claim 8,
wherein the first segment is mechanically connected to the first flange and/or to the second segment; and
wherein the second segment is mechanically connected to the first flange and/or to the first segment.

10. The hollow conductor as claimed in claim 1, further comprising:
a second fastening unit;
wherein the second fastening unit is connected to the second flange; and
wherein the second fastening unit rests against the surface of the flexible hollow conductor section in a second overlap region in a longitudinal direction of the flexible hollow conductor section and engages in a second depression of the flexible hollow conductor section and thereby fixes the flexible hollow conductor section with respect to the second flange.
